(19) United States
(12) Patent Application Publication
(10) Pub. No.: US 2024/0347944 A1
(43) Pub. Date: Oct. 17, 2024

(54) ELECTRICAL CONNECTOR

(71) Applicant: I-PEX Inc., Kyoto-shi, Kyoto (JP)

(72) Inventors: Hiroshi WADA, Ogori-Shi (JP); Akito KOYANAGI, Ogori-Shi (JP)

(21) Appl. No.: 18/683,724

(22) PCT Filed: Aug. 2, 2022
(86) PCT No.: PCT/JP2022/029627

§ 371 Date: Feb. 14, 2024

(30) Foreign Application Priority Data
Aug. 17, 2021 (JP) 2021-132800

(51) Int. Cl. H01R 12/75; H01R 12/70; H01R 12/71

(52) U.S. Cl. CPC H01R 12/75; H01R 12/707; H01R 12/716

(57) ABSTRACT

In a receptacle connector, a conductive contact (11) is a linear member uniform in width in a thickness direction and extending in a plane orthogonal to the thickness direction while curving, and includes: a contacting portion (11a) to contact a plug contact (21) at a first face (30) containing a line extending in the thickness direction; a substrate connecting portion (11b) to connect to a signal electrode (2b) on a substrate (2) at a second face (31) containing a line extending in the thickness direction; and a turnback portion (11c) connected to the contacting portion (11a) and the substrate connecting portion (11b) respectively at first and second ends (32, 33) in a longitudinal direction with a turned-back shape between the first end (32) and the second end (33) in the orthogonal plane. The top (34) of the turnback portion (11c) is pressed into and engaged with the insulation housing.

### TECHNICAL FIELD

The present disclosure relates to an electrical connector.

### BACKGROUND ART

Patent Literature 1 discloses an electrical connector for connecting a signal electrode on a substrate to a signal transmission member of a mating connector, which is formed of a plate and includes a plurality of conductive contacts arranged in a thickness direction of the plate. This electrical connector allows impedance of a conductive contact to be adjusted by changing widths of signal transmission lines for a portion that is disposed between two division walls and a portion that is not disposed between two division walls, the division walls being formed in an insulation housing.

### CITATION LIST

### Patent Literature

Patent Literature 1: Unexamined Japanese Patent Application Publication No. 2021-22488.

### SUMMARY OF INVENTION

### Technical Problem

In the aforementioned electrical connector disclosed in Patent Literature 1, in order to engage the conductive contact with the insulation housing, the conductive contact is provided with a stub-like base that engages with the insulation housing. This stub-like base is a factor that deteriorates a signal transmission characteristic of the electrical connector.

The present disclosure has been accomplished under such circumstances and an objective of the present disclosure is to provide an electrical connector capable of improving a signal transmission characteristic.

### Solution to Problem

In order to achieve the objective described above, an electrical connector according to the present disclosure is an electrical connector mounted on a substrate and configured to mate with a mating connector, the electrical connector including: a conductive contact formed of a plate, the conductive contact being a linear member having a uniform width in a plate thickness direction and extending in an orthogonal plane orthogonal to the plate thickness direction while curving, the conductive contact being configured to contact an electrode on the substrate and a mating contact of the mating connector for transmitting an electric signal and transmit the electric signal between the substrate and the mating connector; and an insulation housing to hold the conductive contact, wherein the conductive contact includes: a contacting portion to contact the mating contact at a first face containing a line extending in the plate thickness direction; a substrate connecting portion to connect to the electrode on the substrate at a second face containing a line extending in the plate thickness direction; and a turnback portion connected to the contacting portion at a first end in a longitudinal direction and connected to the substrate connecting portion at a second end in the longitudinal direction, the turnback portion being located between the first end and the second end and having a turned-back shape in the orthogonal plane, and a top portion of the turnback portion is pressed into the insulation housing to engage with the insulation housing.

The turnback portion may include: a first arm extending from the first end in a direction of press-fitting into the insulation housing; and a second arm extending from the second end in the direction of press-fitting into the insulation housing, and the turnback portion may be formed by connecting an end of the first arm opposite to the first end with an end of the second arm opposite to the second end.

A width of the contacting portion in a direction orthogonal to the first face may be greater than a width of the first arm and a width of the second arm in a direction that is orthogonal to the plate thickness direction and orthogonal to the direction in the orthogonal plane in which the first arm and the second arm extend.

The width of the contacting portion in the direction orthogonal to the first face may be gradually reduced toward the first end.

The contacting portion may extend from the first end and bend in a direction away from the substrate to be disposed opposite to the first arm, and the contacting portion may contact the mating contact in a plane facing against the first arm of the first face.

The conductive contacts may be arranged in the plate thickness direction.

### Advantageous Effects of Invention

According to the present disclosure, the top portion of the turnback portion that serves as a transmission line for transmitting an electric signal between the substrate connecting portion that connects to the electrode on the substrate and the contacting portion that contacts the mating contact engages with the insulation housing; therefore, a signal transmission characteristic can be improved.

### BRIEF DESCRIPTION OF DRAWINGS

FIG. 1 is a perspective view of a connector pair according to Embodiment 1 of the present disclosure;

FIG. 2 is a perspective view of a receptacle connector and a plug connector that constitute the connector pair illustrated in FIG. 1 before mating;

FIG. 3 is an exploded perspective view of the receptacle connector illustrated in FIG. 2;

FIG. 4A illustrates diagrams of a conductive contact, which is illustrated in FIG. 3, that constitutes the receptacle connector viewed from the X-axis direction and the Y-axis direction;

FIG. 4B is a perspective view of the conductive contact illustrated in FIG. 4A;

FIG. 5 is an exploded perspective view of the plug connector illustrated in FIG. 2;

FIG. 6 is a diagram of the receptacle connector illustrated in FIG. 2 viewed from the Y-axis direction;

FIG. 7 is a cross-sectional diagram of the receptacle connector illustrated in FIG. 6 taken along line VII-VII;

FIG. 8 is a cross-sectional diagram of the receptacle connector illustrated in FIG. 6 and the plug connector taken along line VII-VII in FIG. 6 when the receptacle connector and the plug connector are mated with each other;

FIG. 9 is a schematic diagram illustrating how the conductive contact that constitutes the receptacle connector is deformed;

FIG. 10 is a graph illustrating characteristic impedance of a signal transmission line of the connector pair illustrated in FIG. 1;

FIG. 11A is a diagram illustrating a shape of a conductive contact of Comparative Example 1;

FIG. 11B is a graph illustrating characteristic impedance of a signal transmission line of the conductive contact of Comparative Example 1;

FIG. 12A is a diagram illustrating a shape of a conductive contact of Comparative Example 2;

FIG. 12B is a graph illustrating characteristic impedance of a signal transmission line of the conductive contact of Comparative Example 2;

FIG. 13A is a diagram illustrating a shape of a conductive contact of Comparative Example 3;

FIG. 13B is a graph illustrating characteristic impedance of a signal transmission line of the conductive contact of Comparative Example 3;

FIG. 14A is a diagram illustrating a shape of a conductive contact of Comparative Example 4; and

FIG. 14B is a graph illustrating characteristic impedance of a signal transmission line of the conductive contact of Comparative Example 4.

### DESCRIPTION OF EMBODIMENTS

An embodiment of the present disclosure is described in detail below with reference to the drawings. In each drawing, the same or equivalent elements are denoted by same reference signs.

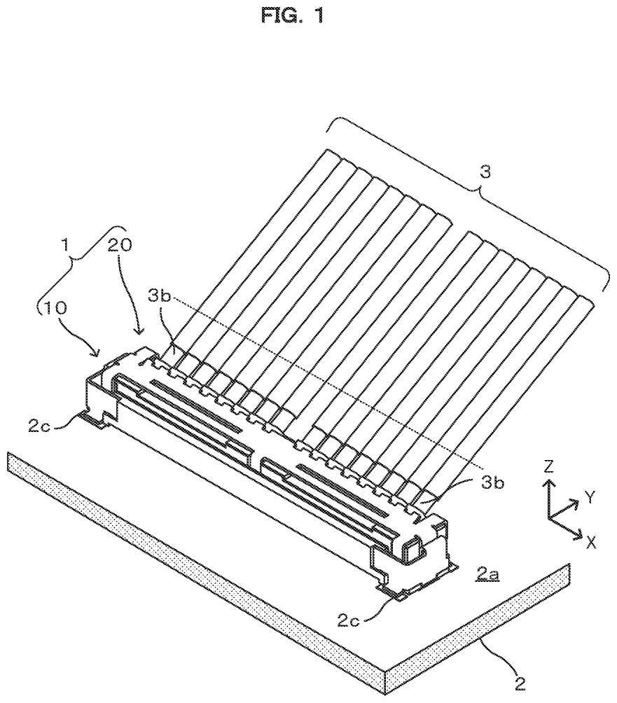

As illustrated in FIG. 1, a connector pair 1 is mounted on a substrate 2. The connector pair 1 connects the substrate 2 to a plurality of coaxial cables 3. Since the coaxial cables 3 are arranged in the X-axis direction, the X-axis direction is defined as a longitudinal direction of the connector pair 1.

Of directions in a principal face 2a (that is, a mounting surface for the connector pair 1) of the substrate 2, the direction in which the coaxial cables 3 are arranged is defined as the X-axis direction and the direction orthogonal to the X-axis direction is defined as the Y-axis direction. A direction orthogonal to the principal face 2a of the substrate 2 is defined as the Z-axis direction. In the present embodiment, description is made with appropriately referring to this XYZ orthogonal coordinate system.

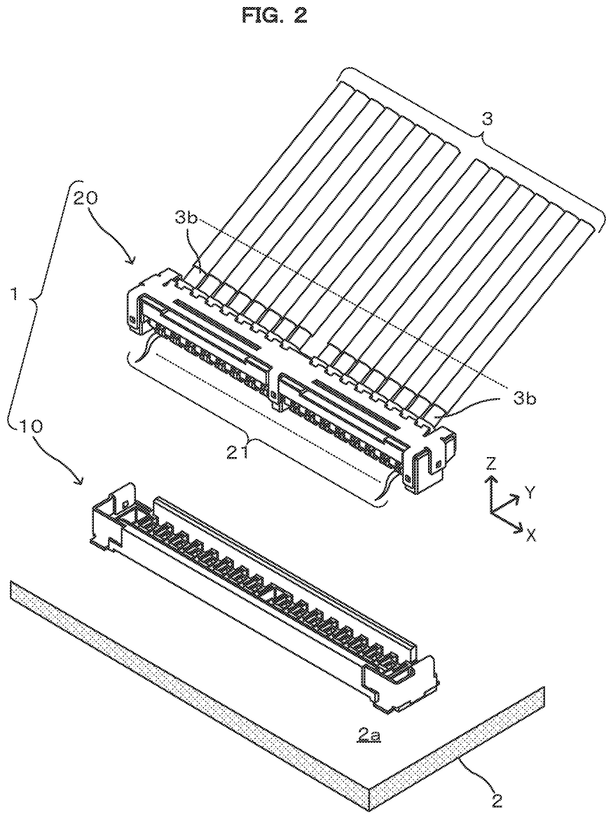

The connector pair 1 includes a receptacle connector 10 serving as an electrical connector according to the present embodiment and a plug connector 20 serving as a mating connector. As illustrated in FIG. 2, the receptacle connector 10 is mounted on the substrate 2 and the plug connector 20 is connected to the coaxial cables 3. The receptacle connector 10 is generally formed to be a concave shape. By plugging the plug connector 20 into a portion having such a concave shape, the mated configuration illustrated in FIG. 1 is achieved. With this mating, connections between the substrate 2 and the plurality of coaxial cables 3 are achieved in the connector pair 1.

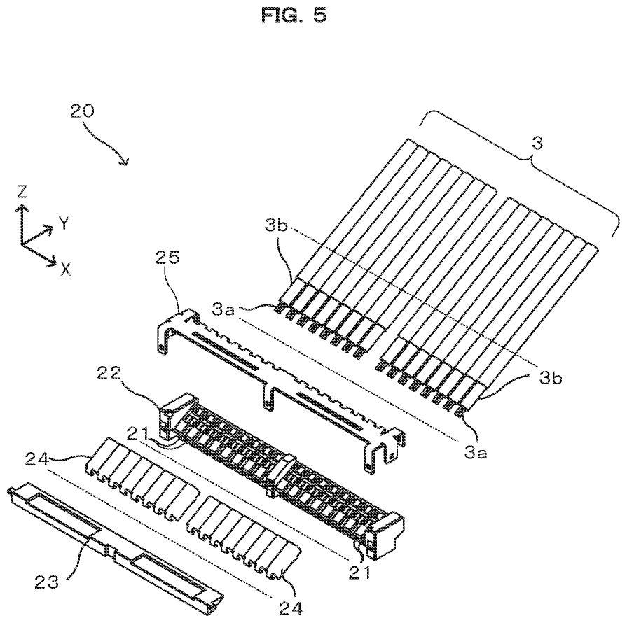

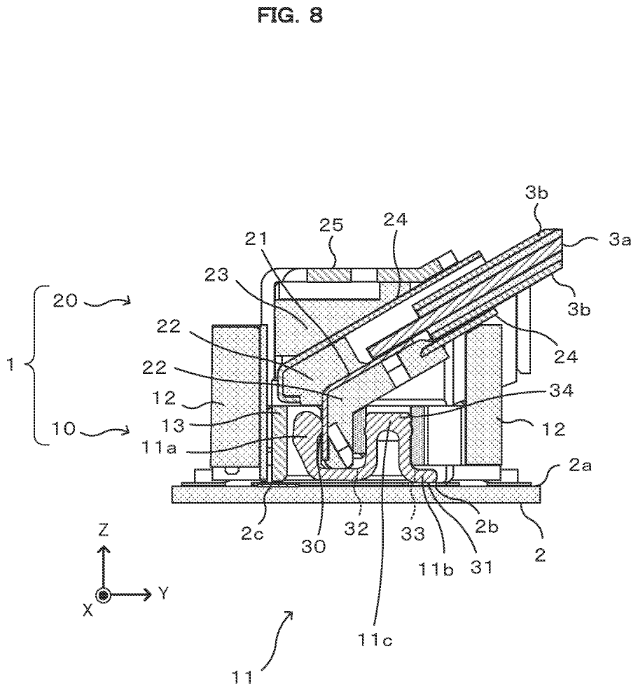

In the present embodiment, the coaxial cable 3 contains a pair of signal lines (internal conductor) 3a (see FIG. 5). An external conductor 3b is provided around a pair of the signal lines 3a via an insulator. A pair of the signal lines 3a and the external conductor 3b transmit a differential signal. The coaxial cables 3 are arranged in the X-axis direction in a state in which signal lines 3a thereof are facing against each other in the X-axis direction. As illustrated in FIG. 2, the plug connector 20 includes plug contacts 21 arranged in the X-axis direction each serving as a mating contact. The plug contact 21 is connected to the signal line 3a of the coaxial cable 3 (see FIG. 8).

### Receptacle Connector

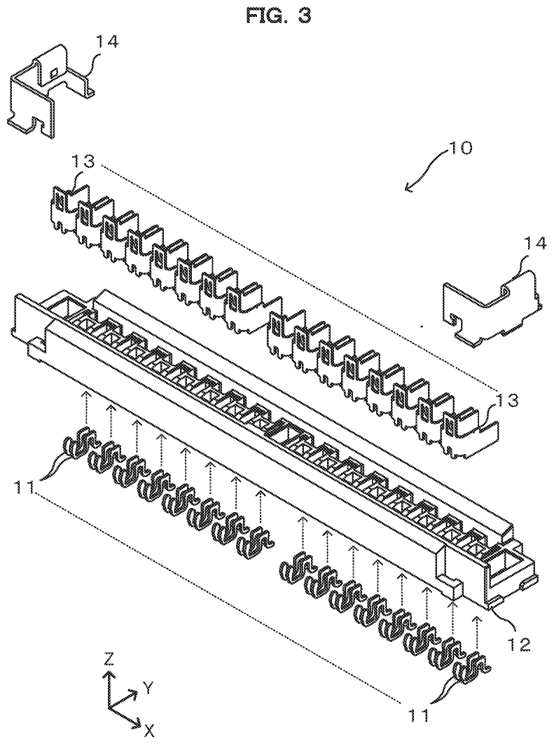

First, a configuration of the receptacle connector 10 is described. As illustrated in FIG. 3, the receptacle connector 10 includes a conductive contact 11, an insulation housing 12, a shell 13, and a fixing bracket 14.

The conductive contact 11 is formed of an electrically conductive material, such as metal. A plurality of conductive contacts 11 is provided and arranged in a line along the X-axis direction. A pair of conductive contacts 11 makes one set. The pairs of conductive contacts 11 are arranged in such a way that each conductive contact in a single pair of conductive contacts 11 is connected to each signal line of a pair of the signal lines 3a of a single coaxial cable 3 via the plug contact 21 of the plug connector 20.

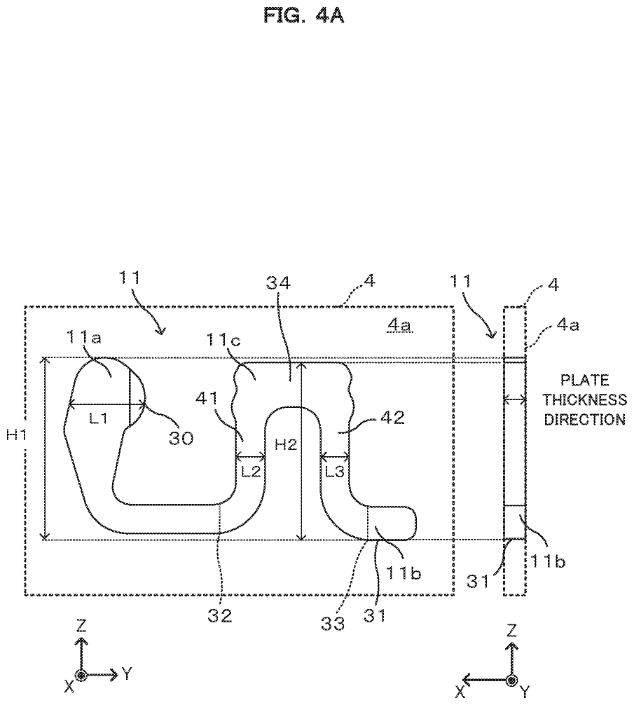

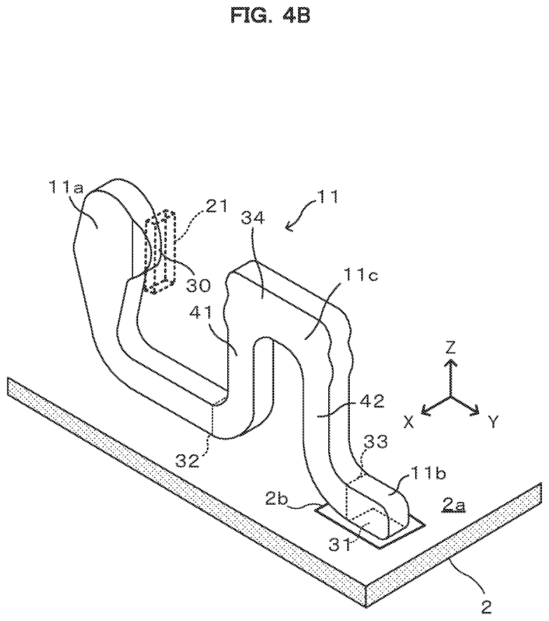

The conductive contact 11 is a member formed of an electrically conductive plate 4 as illustrated in FIG. 4A. The conductive contact 11 is formed by punching the plate 4. Accordingly, the conductive contact 11 has a uniform width dimension in a thickness direction of the plate 4. The conductive contacts 11 are arranged as illustrated in FIG. 3 and FIG. 4A in such a way that the thickness direction of the plate 4 coincides with the X-axis direction. The conductive contact 11 is, as illustrated in FIG. 4A, a linear member extending in an imaginary orthogonal plane 4a orthogonal to the thickness direction of the plate 4 while curving. The language “linear” used herein means a shape extending in one direction with a uniform width and traversable without any branches.

As illustrated in FIG. 4B, the conductive contact 11 contacts a signal electrode 2b on the substrate 2 at one end thereof and contacts the plug contact 21 of the plug connector 20 at the other end. The conductive contact 11 transmits an electric signal between the substrate 2 and the plug connector 20.

Referring back to FIG. 3, the insulation housing 12 is formed of a material having an insulating property, such as resin. The insulation housing 12 extends in the X-axis direction and the length thereof is equal to or greater than a length of an array of the conductive contacts 11. The insulation housing 12 holds the conductive contacts 11. The insulation housing 12 is provided with press-fit holes each serving as a hole for press-fitting and engaging with each pair of conductive contacts 11. The press-fit hole penetrates through in the Z-axis direction. A pair of the conductive contacts 11 is pressed into the press-fit hole from below the insulation housing 12 into the +Z direction and held by the insulation housing 12. The press-fit holes are arranged in the X-axis direction in such a way as to be in line with the array of the conductive contacts 11.

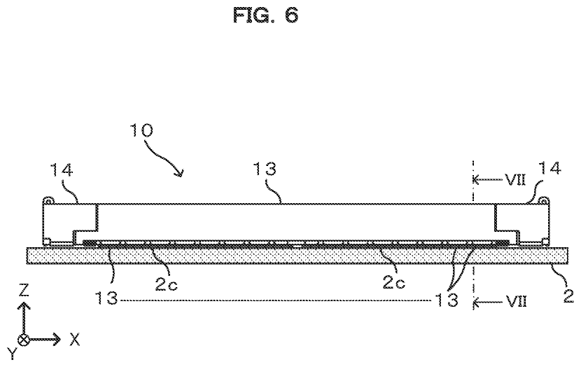

The shell 13 is formed of an electrically conductive material, such as metal. A plurality of shells 13 is provided and arranged in a line along the X-axis direction. The insulation housing 12 is provided with press-fit holes each serving as a hole for press-fitting and engaging with each shell 13. The press-fit hole penetrates through in the Z-axis direction. The shell 13 is pressed into the press-fit hole from above the insulation housing 12 into the −Z direction, engaged with the insulation housing 12, and held by the insulation housing 12. The shell 13 has a U-shape when viewed from the Z-axis direction. The shell 13 is disposed spaced apart from a pair of the conductive contacts 11 for transmitting a differential signal when viewed from the Z-axis direction (in an insulated state) in such a way that a pair of the conductive contacts 11 is surrounded by the U-shape. As illustrated in FIG. 6, the shell 13 is soldered to a ground electrode 2c on the substrate 2.

The fixing bracket 14 is a bracket for fixing the receptacle connector 10 to the substrate 2. The fixing brackets 14 are provided as a pair. The fixing brackets 14 engages with the insulation housing 12 in such a way as to sandwich the insulation housing 12 at both ends of the insulation housing 12 in the X-axis direction. As illustrated in FIG. 1, the fixing bracket 14 is fixed to the ground electrode 2c on the substrate 2 by soldering. With the fixing bracket 14, the receptacle connector 10 is mounted on the substrate 2.

### Plug Connector

Next, a configuration of the plug connector 20 is described. As illustrated in FIG. 5, the plug connector 20 includes the aforementioned plug contact 21, a first insulation housing 22, a second insulation housing 23, a shell 24, and a cover 25.

The plug contact 21 is an electrically conductive member and is provided for each signal line 3a of the coaxial cable 3 as described above. The first insulation housing 22 is a member having an insulating property and holds the plug contacts 21 that are arranged in the X-axis direction. The plug contacts 21 and the first insulation housing 22 are integrally molded (insert-molded). The plug contact 21 is connected at one end to the signal line 3a of the coaxial cable 3 by soldering and exposed to the outside at the other end to allow the other end to contact the conductive contact 11 of the receptacle connector 10.

The second insulation housing 23 is a member having an insulating property and constitutes a main body of the plug connector 20 together with the first insulation housing 22. The shell 24 is an electrically conductive member. The shell 24 is disposed in such a way that the shell 24 surrounds a pair of plug contacts 21 connected to a pair of signal lines 3a of the coaxial cable 3. The shell 24 is sandwiched between and held by the first insulation housing 22 and the second insulation housing 23. The cover 25 is an electrically conductive member and covers the first insulation housing 22 from above. The shell 24 is connected to the external conductor 3b of the coaxial cable 3 by soldering. The cover 25 is connected to the shell 24 by soldering.

### Configuration of Connector Pair

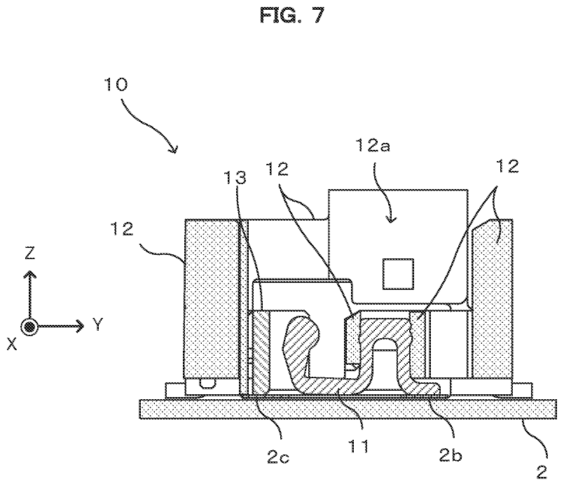

As described above, a concave portion 12a that is recessed in the −Z direction is provided in the insulation housing 12 of the receptacle connector 10 as illustrated in FIG. 7, which is a cross-sectional diagram of the receptacle connector illustrated in FIG. 6 taken along line VII-VII. As illustrated in FIG. 7 and FIG. 8, the plug connector 20 is inserted into the concave portion 12a. In this manner, mating of the receptacle connector 10 and the plug connector 20 is accomplished. In the mated state, the coaxial cable 3 extends in the +Y direction in a sloped manner from the Z-axis.

As illustrated in FIG. 8, with mating of the receptacle connector 10 and the plug connector 20, the plug contact 21 of the plug connector 20 contacts the conductive contact 11 of the receptacle connector 10. In this manner, a transmission line is formed by the signal line (internal conductor) 3a of the coaxial cable 3, the plug contact 21, the conductive contact 11, and the signal electrode 2b on the substrate 2. A pair of the signal lines 3a, the plug contacts 21, the conductive contacts 11, and the signal electrodes 2b works as one unit and transmits a differential signal.

In addition, with mating of the receptacle connector 10 and the plug connector 20, the shell 24 and the cover 25 contact the shell 13 of the receptacle connector 10. The shell 13 is connected to the ground electrode 2c on the substrate 2. In this manner, a ground line is formed by the external conductor 3b of the coaxial cable 3, the shell 24 and the cover 25, the shell 13, and the ground electrode 2c on the substrate 2.

The shell 24 and the cover 25 surround a pair of the plug contacts 21 while the shell 13 surrounds a pair of the conductive contacts 11. This means that the aforementioned ground line surrounds the signal transmission line of the differential signal described above from the coaxial cable 3 to the substrate 2. Accordingly, intrusion and leakage of noises into and from the transmission line of the differential signal can be prevented and the transmission characteristic can be improved.

### Detailed Configuration of Conductive Contact

The detailed configuration of the conductive contact 11 that constitutes the receptacle connector 10 is described. As illustrated in FIG. 4A and FIG. 4B, the conductive contact 11 includes a contacting portion 11a, a substrate connecting portion 11b, and a turnback portion 11c.

The contacting portion 11a includes a portion extending in the Z-axis direction that contacts the plug contact 21 and a portion extending in the Y-axis direction. An end of the portion extending in the Z-axis direction on the side of −Z is connected to an end of the portion extending in the Y-axis direction on the side of −Y. In other words, the contacting portion 11a is L-shaped when viewed from the X-axis direction. The substrate connecting portion 11b is a linear portion extending in the Y-axis direction and fixed to the signal electrode 2b on the substrate 2 by soldering. The turnback portion 11c is a portion extending in a linear manner while curving and connecting the contacting portion 11a to the substrate connecting portion 11b. In a state in which the substrate connecting portion 11b is connected to the signal electrode 2b, the portion of the contacting portion 11a extending in the Y-axis direction is separate from the substrate 2, and the portion may be elastically deformed about the X-axis.

As illustrated in FIG. 4A and FIG. 4B, an imaginary line extending in the thickness direction of the plate 4 is assumed. In the conductive contact 11, a plane containing this line corresponds to a cutting surface formed by punching the plate 4. The contacting portion 11a contacts the plug contact 21 at a first face 30, which is one of such cutting surfaces that contains a line extending in the thickness direction of the plate 4. The substrate connecting portion 11b is connected to the signal electrode 2b on the substrate 2 at a second face 31, which is one of such cutting surfaces that contains a line extending in the thickness direction of the plate 4. Note that the orthogonal plane 4a is an imaginary plane orthogonal to the line as described above and in FIG. 4A, a principal face of the plate 4 is illustrated as an example of the orthogonal plane 4a.

An end of the turnback portion 11c on the side of −Y is assumed to be a first end 32. The first end 32 is connected to an end of the contacting portion 11a extending in the Y-axis direction on the side of the +Y. The other end of the turnback portion 11c on the side of +Y is assumed to be a second end 33. The second end 33 is connected to an end of the substrate connecting portion 11b on the side of −Y. The turnback portion 11c extends between the first end 32 and the second end 33 while curving. In other words, the first end 32 and the second end 33 are two opposite ends in the longitudinal direction of the turnback portion 11c. In the turnback portion 11c, the first end 32 is connected to the contacting portion 11a and the second end 33 is connected to the substrate connecting portion 11b. The turnback portion 11c has a shape that is turned back between the first end 32 and the second end 33 in the orthogonal plane 4a. Specifically, the turnback portion 11c has a shape extending from the first end 32 in the +Z direction, then being bent in the +Y direction and again being bent in the −Z direction and extending to the second end 33.

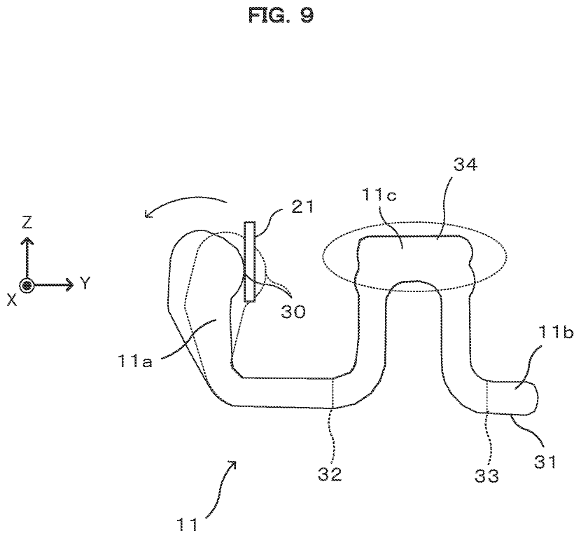

As illustrated in FIG. 8, a top portion 34 of the turnback portion 11c on the side of +Z is pressed into the press-fit hole of the insulation housing 12 to engage with the insulation housing 12. With this engagement, the conductive contact 11 is held by the insulation housing 12. Accordingly, as illustrated in FIG. 9, when the receptacle connector 10 and the plug connector 20 are mated, the contacting portion 11a contacts the plug contact 21. When this contact is made, the contacting portion 11a rotates about the X-axis with the turnback portion 11c, which is fixed to the insulation housing 12, as a fulcrum point. The elastic force generated at the contacting portion 11a becomes a pressing force against the plug contact 21.

The turnback portion 11c is formed between the contacting portion 11a and the substrate connecting portion 11b; in other words, the turnback portion 11c is configured that a reaction due to deformation of the contacting portion 11a is not transmitted to the substrate connecting portion 11b. Accordingly, the conductive contact 11 can maintain a stable connection with the signal electrode 2b on the substrate 2.

In addition, the turnback portion 11c that engages with the insulation housing 12 is a signal transmission line. Since the conductive contact 11 is not provided with a stub that engages with the insulation housing 12, the signal transmission characteristic can be improved.

More specifically, the turnback portion 11c includes, as illustrated in FIG. 4A, a first arm 41 extending from the first end 32 in a direction of press-fitting into the insulation housing 12 and a second arm 42 extending from the second end 33 in a direction of press-fitting into the insulation housing 12. The turnback portion 11c is formed by connecting an end of the first arm 41 opposite to the first end 32 with an end of the second arm 42 opposite to the second end 33.

As illustrated in FIG. 4A, a width L1 of the contacting portion 11a in a direction (the Y-axis direction) orthogonal to the first face 30 is greater than a width L2 of the first arm 41 in a direction (the Y-axis direction) that is orthogonal to the thickness direction of the plate 4 and orthogonal to the direction in the orthogonal plane 4a in which the first arm 41 and the second arm 42 extend and similarly greater than a width L3 of the second arm 42 in the Y-axis direction. If the width L1 of the contacting portion 11a is equal to the width L2 of the first arm 41 and equal to the width L3 of the second arm 42, the characteristic impedance of the contacting portion 11a for transmitting a signal by contacting the plug contact 21 increases at the portion having the width L1. In order to reduce the characteristic impedance at the portion having the width L1, the width L1 of the contacting portion 11a is configured to be greater. As the width L1 is greater, a capacity component of the characteristic impedance can be increased.

In the present embodiment, the width L2 of the first arm 41 and the width L3 of the second arm 42 are equal. As described above, the turnback portion 11c is configured in such a way that the width along a direction in which a signal is transmitted in the orthogonal plane 4a is configured to be as uniform as possible.

The width L1 of the contacting portion 11a in the direction (the Y-axis direction) orthogonal to the first face 30 is gradually reduced from the first face 30 at which the plug contact 21 contacts toward the first end 32. If the width L1 of the contacting portion 11a is kept wide along the Z-axis direction, it is conceivable that the contacting portion 11a will not be sufficiently deformed when the plug contact 21 abuts against the contacting portion 11a. Therefore, in the present embodiment, the contacting portion 11a is thinned down toward the first end 32 to facilitate deformation of the contacting portion 11a about the X-axis and keep the elastic force for pressing the plug contact 21 at an appropriate level.

Although the contacting portion 11a extends from the first end 32 and bends in a direction away from the substrate 2 to be disposed against the first arm 41, the contacting portion 11a may contact the plug contact 21 at a face located on the side of −Y. However, in the present embodiment, the contacting portion 11a contacts the plug contact 21 at a first face 30 facing against the first arm 41, which is one of cutting surfaces along the thickness direction of the plate 4. This configuration can improve the transmission characteristic for electric signals of the connector pair 1 compared to the case in which the contacting portion 11a contacts the plug contact 21 at a face located on the side of −Y.

In addition, this configuration enables the plug contact 21 to enter between the contacting portion 11a and the first arm 41, which allows the connector pair 1 to be downsized. As illustrated in FIG. 8, the reaction to the deformation of the contacting portion 11a when the plug connector 20 is inserted into the receptacle connector 10 is applied in a direction of press-fitting the turnback portion 11c into the press-fit hole of the insulation housing 12, which makes the conductive contact 11 to be hardly removed from the insulation housing 12.

As illustrated in FIG. 4A, a height H1 of the first face 30 of the contacting portion 11a from the substrate 2 is a little higher than or approximately equal to a height H2 of the turnback portion 11c from the substrate 2. The height H1 is defined based on an elastic force required for the contact with the plug contact 21 while the height H2 of the turnback portion 11c is defined based on a force required for engagement with the insulation housing 12. When the heights H1 and H2 are approximately equal, the whole conductive contact 11 can be contained in a rectangle when viewed from the X-axis direction; therefore, a total space required for the conductive contact 11 can be reduced. The heights H1 and H2 and the length of the conductive contact 11 in the X-axis direction may be appropriately determined in accordance with specifications required for the receptacle connector 10.

Next, a behavior of the receptacle connector 10 according to the embodiment of the present disclosure is described. The shape of the conductive contact 11 described above affects the transmission characteristic for electric signals of the receptacle connector 10. Evaluation of characteristic impedance of the signal transmission line when using the conductive contact 11 is described below. The evaluation can be performed by means of time domain reflectometry (TDR).

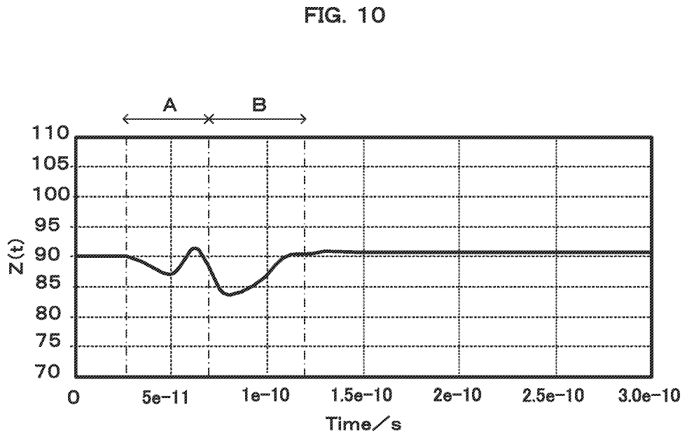

FIG. 10 illustrates the characteristic impedance of the signal transmission line of the connector pair 1 according to the present embodiment with the vertical axis indicating the characteristic impedance and the horizontal axis indicating time. The characteristic impedance of the connector pair 1 is determined when an electric signal is transmitted from the signal electrode 2b on the substrate 2 to the signal line of the coaxial cable 3.

In FIG. 10, ranges A and B indicate the characteristic impedance of the connector pair 1. The range A indicates the characteristic impedance of the conductive contact 11 of the receptacle connector 10 while the range B indicates the characteristic impedance of the plug contact 21 of the plug connector 20. Ranges other than these indicate characteristic impedance of the signal line 3a of the coaxial cable 3 and a circuit including the signal electrode 2b on the substrate 2.

Since the characteristic impedance of the signal line 3a of the coaxial cable 3 and the circuit including the signal electrode 2b on the substrate 2 is 90Ω, the characteristic impedance of the connector pair 1 is preferably 90 Ω in order to match the characteristic impedance. As illustrated in FIG. 10, the characteristic impedance in the range A and the characteristic impedance in the range B remain around 90Ω (a range between 83Ω and 91Ω) although a slight drop is observed.

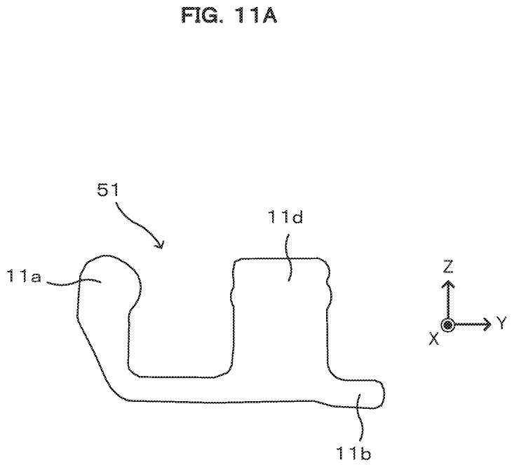

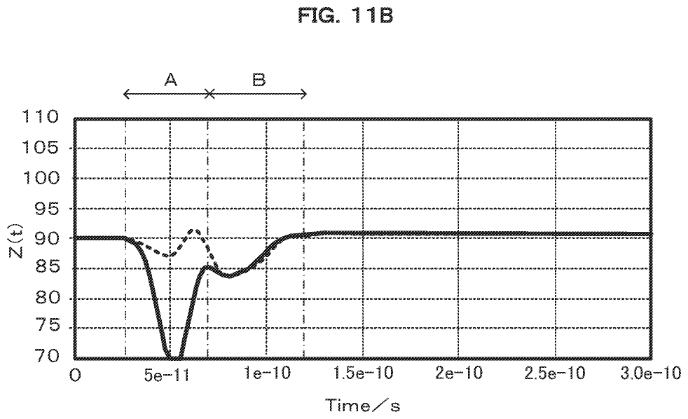

FIG. 11A illustrates a conductive contact 51 that engages with the insulation housing 12 using a stub 11d. This conductive contact 51 has the same thickness in the X-axis direction as the conductive contact 11 according to the present embodiment. The dimension of the shape of the stub 11d is the same as that of the turnback portion 11c.

FIG. 11B is a graph in which characteristic impedance (the solid line) when using the conductive contact 51 and the characteristic impedance (the dotted line) when using the conductive contact 11 according to the present embodiment are compared. As illustrated in FIG. 11B, when the conductive contact 51 is used, the characteristic impedance is substantially lower in the range A than that of the conductive contact 11 according to the present embodiment. In other words, using the conductive contact 11 prevents a drop in the characteristic impedance in the range A.

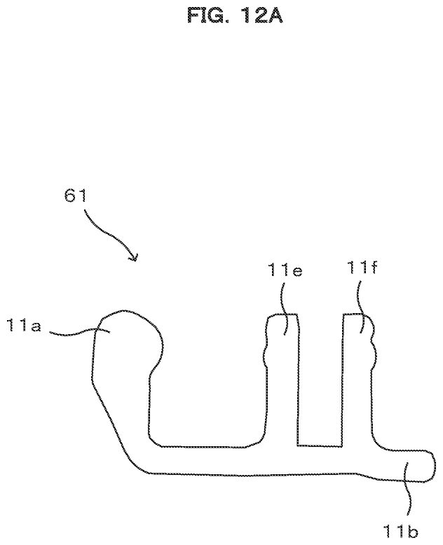

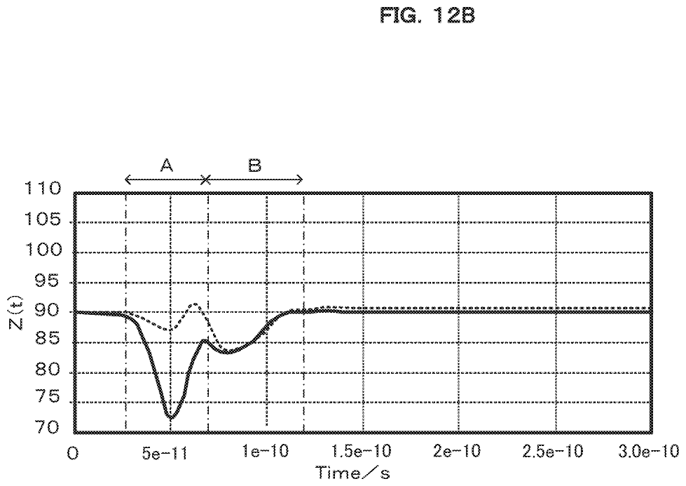

FIG. 12A illustrates a conductive contact 61 including two stubs 11e and 11f as engagement portions. This conductive contact 61 has the same thickness in the X-axis direction as the conductive contact 11. In the conductive contact 61, the combined areas of the two stubs 11e and 11f when viewed from the X-axis direction are the same as that of the turnback portion 11c of the conductive contact 11 according to the present embodiment when viewed from the X-axis direction.

FIG. 12B is a graph in which characteristic impedance (the solid line) when using the conductive contact 61 and the characteristic impedance (the dotted line) when using the conductive contact 11 according to the present embodiment are compared. As illustrated in FIG. 12B, although a drop in the characteristic impedance in the range A when the conductive contact 61 is used is reduced compared to that of the conductive contact 51 using the stub 11d (see FIG. 11B), the characteristic impedance is lower than that of the conductive contact 11 according to the present embodiment.

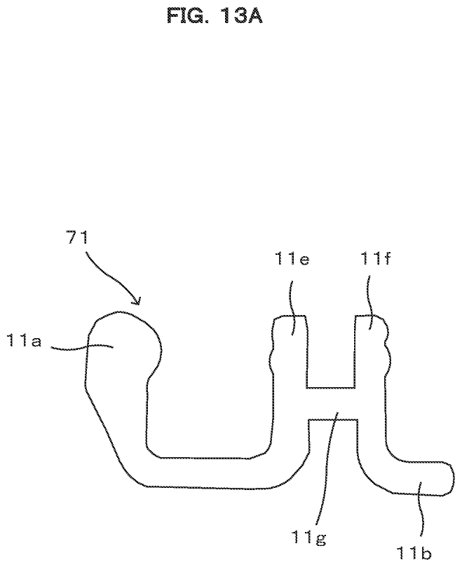

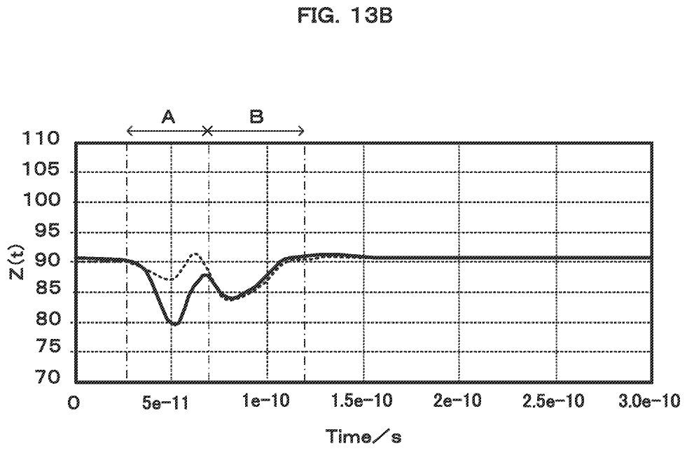

FIG. 13A illustrates a conductive contact 71 including two stubs 11e and 11f as engagement portions. This conductive contact 71 has the same thickness in the X-axis direction as the conductive contact 11 according to the present embodiment. In this conductive contact 71, a transmission line 11g between the stub 11e and the stub 11f is farther from the substrate 2, and the stubs 11e and 11f and the transmission line 11g forms an H-shaped member when viewed from the X-axis direction. When viewed from the X-axis direction, the combined areas of the stubs 11e and 11f and the transmission line 11g is the same as that of the conductive contact 11 according to the present embodiment.

FIG. 13B is a graph in which characteristic impedance (the solid line) when using the conductive contact and the characteristic impedance (the dotted line) when using the conductive contact 11 according to the present embodiment (see FIG. 4A) are compared. As illustrated in FIG. 13B, although a drop in the characteristic impedance (the solid line) in the range A when the conductive contact 71 is used is reduced compared to that of the conductive contact 61 using the stubs 11e and 11f (see FIG. 12B), the characteristic impedance is lower than that (the dotted line) of the conductive contact 11 according to the present embodiment.

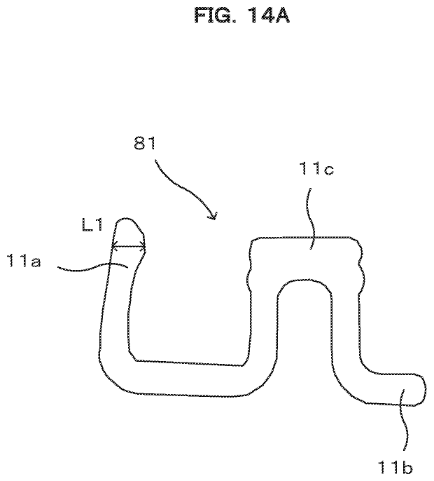

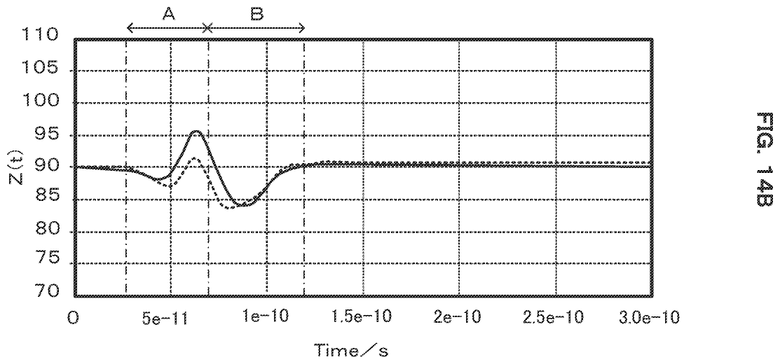

FIG. 14A illustrates a conductive contact 81 in which the width L1 of the contacting portion 11a is reduced compared to that of the conductive contact 11. This conductive contact 81 has the same thickness in the X-axis direction as the conductive contact 11.

FIG. 14B is a graph in which characteristic impedance (the solid line) when using the conductive contact 81 and the characteristic impedance when using the conductive contact 11 according to the present embodiment are compared. As illustrated in FIG. 14B, when the conductive contact 81 is used, the characteristic impedance (the solid line) is 95 Ω or higher near a boundary between the range A and the range B, in other words, near the contacting portion 11a. However, by increasing the width L1 of the contacting portion 11a as in the conductive contact 11, the characteristic impedance near the contacting portion 11a can be adjusted to 90Ω.

As described in detail above, in the receptacle connector 10 according to the embodiment described above, the turnback portion 11c that serves as a transmission line for transmitting an electric signal engages with the insulation housing 12 at the top portion 34, the turnback portion 11c being formed between the substrate connecting portion 11b that connects to the signal electrode 2b on the substrate 2 and the contacting portion 11a that contacts the plug contact 21. Accordingly, a stub that engages with the insulation housing 12 is not necessary to be formed, and the transmission characteristic for electric signals of the transmission line can be improved.

As illustrated in FIG. 4A, in the conductive contact 11 of the receptacle connector 10 according to the embodiment described above, the turnback portion 11c includes the first arm 41 extending from the first end 32 in the direction of press-fitting into the insulation housing 12 and the second arm 42 extending from the second end 33 in the direction of press-fitting into the insulation housing 12. The turnback portion 11c is formed by connecting an end of the first arm 41 opposite to the first end 32 with an end of the second arm 42 opposite to the second end 33. In this case, the turnback portion 11c can be formed just by protruding a portion in the +Z direction once, therefore the length of the transmission line in the turnback portion 11c can be reduced as short as possible.

Note that the shape of the turnback portion 11c is not limited to the one described above. For example, a portion that curves twice or more may be used as the turnback portion 11c. In this case, the height of the turnback portion 11c can be made shorter than that of the turnback portion 11c in the present embodiment. The height of each portion in the turnback portion 11c does not have to be the same.

In the receptacle connector 10 according to the embodiment described above, the width L1 of the contacting portion 11a in the direction orthogonal to the first face 30 is greater than the width L2 of the first arm 41 and similarly greater than the width L3 of the second arm 42 in the direction that is orthogonal to the plate thickness direction and orthogonal to the direction in the orthogonal plane 4a in which the first arm 41 and the second arm 42 extend. In this manner, as illustrated in FIG. 10, the characteristic impedance near the contacting portion 11a can be adjusted to around 90Ω.

Which of the characteristic impedance in the range A and the characteristic impedance in the range B should be adjusted to 90Ω depends on the required specification. When it is desired to make the characteristic impedance in the entirety of the ranges A and B as close to 90 Ω as possible, the width L1 of the contacting portion 11a may be different in dimension. The width L1 of the contacting portion 11a may be finely adjusted in such a way that the characteristic impedance in the ranges A and B is as close to 90Ω as possible.

In the receptacle connector 10 according to the embodiment described above, the width L1 of the contacting portion 11a in the direction orthogonal to the first face 30 is gradually reduced toward the first end 32. In this manner, even if the maximum value of the width L1 of the contacting portion 11a is increased, the contacting portion 11a can still deform about the X-axis, and the contacting portion 11a can contact the plug contact 21 with an appropriate pressing force.

In the receptacle connector 10 according to the embodiment described above, the contacting portion 11a extends from the first end 32 and bends in a direction away from the substrate 2 to be disposed against the first arm 41. The contacting portion 11a contacts the plug contact 21 in a plane facing against the first arm 41 of the first face 30. In this manner, the transmission characteristic of the signal transmission line can be improved and on top of that, the entire size of the connector pair 1 can be reduced.

In the receptacle connector 10 according to the embodiment described above, the conductive contacts 11 are arranged in the plate thickness direction (the X-axis direction). In this manner, since the widths of the conductive contacts 11 in the plate thickness direction are uniform, the conductive contacts 11 can be arranged in the X-axis direction at a small interval. Thus, the entire size of the connector pair 1 can be reduced.

In the embodiment described above, the receptacle connector 10 includes the shell 13 that surrounds the conductive contact 11. However, the present disclosure is not limited to this configuration. The receptacle connector 10 may not include the shell 13.

In the embodiment described above, a single coaxial cable 3 includes two signal lines 3a, thus the single coaxial cable 3 is capable of transmitting a differential signal. However, the present disclosure is not limited to this configuration. The coaxial cable 3 may be configured to transmit one electric signal. Alternatively, a coaxial cable 3 that transmits three or more electric signals may be employed.

The connector pair 1 according to the embodiment described above connects the coaxial cable 3 to the substrate 2 in such a way that the coaxial cable 3 is inclined from the Z-axis direction relative to the principal face 2a of the substrate 2. However, the present disclosure is not limited to this configuration. The coaxial cable 3 may be configured to connect to the substrate 2 along the Z-axis direction. The present disclosure is not limited by the orientation of the coaxial cable 3 relative to the substrate 2.

The connector pair 1 according to the embodiment described above connects a plurality of coaxial cables 3 to the substrate 2. However, the present disclosure is not limited to this configuration. The connector pair 1 may be configured to connect a single coaxial cable 3 to the substrate 2.

The receptacle connector 10 according to the embodiment described above is configured to connect the substrate 2 to the coaxial cables 3. However, the present disclosure is not limited to this configuration. The receptacle connector 10 may be a connector that connects a substrate with another substrate. Such substrates include flexible substrates such as Flexible Printed Circuits (FPC) in addition to the substrate 2.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Unexamined Japanese Patent Application Publication No. 2021-132800, filed on Aug. 17, 2021, the entire disclosure of which is incorporated by reference herein.

### INDUSTRIAL APPLICABILITY

The present disclosure may be applied to an electrical connector for connecting electrical components and transmitting an electric signal.

### REFERENCE SIGNS LIST

1 Connector pair
2 Substrate
2a Principal face
2b Signal electrode
2c Ground electrode
3 Coaxial cable
3a Signal line (internal conductor)
3b External conductor
4 Plate
4a Orthogonal plane
10 Receptacle connector (electrical connector)
11 Conductive contact
11a Contacting portion
11b Substrate connecting portion
11c Turnback portion
11d, 11e, 11f Stub
11g Transmission line
12 Insulation housing
12a Concave portion
13 Shell
14 Fixing bracket
20 Plug connector (mating connector)
21 Plug contact (mating contact)
22 First insulation housing
23 Second insulation housing
24 Shell
25 Cover
30 First face
31 Second face
32 First end
33 Second end
34 Top portion
41 First arm
42 Second arm
51, 61, 71, 81 Conductive contact

1. An electrical connector mounted on a substrate and configured to mate with a mating connector, the electrical connector comprising:
a conductive contact formed of a plate, the conductive contact being a linear member having a uniform width in a plate thickness direction and extending in an orthogonal plane orthogonal to the plate thickness direction while curving, the conductive contact being configured to contact an electrode on the substrate and a mating contact of the mating connector for transmitting an electric signal and transmit the electric signal between the substrate and the mating connector; and
an insulation housing to hold the conductive contact, wherein the conductive contact includes:
a contacting portion to contact the mating contact at a first face containing a line extending in the plate thickness direction;
a substrate connecting portion to connect to the electrode on the substrate at a second face containing a line extending in the plate thickness direction; and
a turnback portion connected to the contacting portion at a first end in a longitudinal direction and connected to the substrate connecting portion at a second end in the longitudinal direction, the turnback portion being located between the first end and the second end and having a turned-back shape in the orthogonal plane, and
a top portion of the turnback portion is pressed into the insulation housing to engage with the insulation housing.

2. The electrical connector according to claim 1, wherein the turnback portion includes:
a first arm extending from the first end in a direction of press-fitting into the insulation housing; and
a second arm extending from the second end in the direction of press-fitting into the insulation housing, and the turnback portion is formed by connecting an end of the first arm opposite to the first end with an end of the second arm opposite to the second end.

3. The electrical connector according to claim 2, wherein a width of the contacting portion in a direction orthogonal to the first face is greater than a width of the first arm and a width of the second arm in a direction that is orthogonal to the plate thickness direction and orthogonal to the direction in the orthogonal plane in which the first arm and the second arm extend.

4. The electrical connector according to claim 3, wherein the width of the contacting portion in the direction orthogonal to the first face is gradually reduced toward the first end.

5. The electrical connector according to claim 2, wherein the contacting portion extends from the first end and bends in a direction away from the substrate to be disposed opposite to the first arm, and
the contacting portion contacts the mating contact in a plane facing against the first arm of the first face.

6. The electrical connector according to claim 1, wherein the conductive contacts are arranged in the plate thickness direction.
